(19) United States
(12) Patent Application Publication
(10) Pub. No.: US 2013/0048811 A1
(43) Pub. Date: Feb. 28, 2013

(54) A MOUNTING KIT

(71) Applicants: Yi-Chen TSENG, Beidou Township (TW); Chia-Cheng Chen, Taichung City (TW)

(72) Inventors: Yi-Chen TSENG, Beidou Township (TW); Chia-Cheng Chen, Taichung City (TW)

(21) Appl. No.: 13/221,372

(22) Filed: Aug. 30, 2011

(51) Int. Cl. F16M 13/02; F16M 13/00

(52) U.S. Cl. 248/220.21; 248/279.1

(57) ABSTRACT

The present invention is related to a mounting kit comprising a mother base, a son base and a connection unit. The mother base is disposed to a fixed object with a storage space to move up/down and/or turning left/right and fastened to a position of the fixed object. The son base is correspondingly connected to the storage space which permits the user to choose to move inward or outward and fastened to a position. The connection unit is correspondingly connected to the son base which to make up/down and or facing downward/upward adjustment and fastened to a position. Its front can be disassembled for fastening to the back of the display device or the back of the supporting object. Hence, the invention can steadfastly fasten different brands and different measurements of display devices to a fixed object (or its supporting rod), and adjust the best viewing angle for the user.

### BACKGROUND OF THE INVENTION

1. Field of the Invention

The present invention discloses a physical media for connection use, or more particularly to a mounting kit for fastening a display device.

2. Description of the Prior Art

Nowadays, display devices such as the computer monitor, monitor screen and TV are becoming slimmer, flat and high picture quality. Such display devices are generally hung on the wall of the living environment by means of a hanging rack as the media. The hanging rack is a metal sheet after punching with considerable strength and the one-piece unit may be hung on the wall and installed along with bolts and nuts on a plurality of screw holes for fastening the display device.

However, the hanging rack cannot be applied to different brands and different measurements display devices, and therefore its practical application is not extensive. Furthermore, the hanging rack is comparatively easier for mounting on a planar surface such as a wall but difficult for mounting on an are surface of a pillar body. Also, once the hanging rack is fastened onto the wall, the viewing angle of the display device and the wall for the viewer is fixed and cannot be adjusted any more, except replacing a hanging rack with different tilt angle so as to tailor to the viewing angle of another viewer.

### SUMMARY OF THE INVENTION

The purpose of the present invention is to provide a mounting kit which may expand the scope of application to different brands and different measurements of display devices to be stably fastened to a fixed object (or its supporting rod).

Another purpose of the present invention is to provide a mounting kit so that the user can adjust the display device for the best viewing angle in space.

To achieve the aforementioned disclosed purpose the present invention mounting kit comprises:

a mother base disposed on a fixed object which may provide the user the option of up/down and left/right adjustment and fastened to a position. The mother base has a storage space, and sets of holes corresponding to the fixed object, and respectively dented to form on both sides of the surface in the storage space and disposed a starting end connecting externally to the mother base and a chute at the end inside the mother base which successively correspond to the starting end; and the two sets horizontally correspond to the upper and lower positions of the chute and spatially adjacent to the holes of the starting end of the chute. And a fastening element disposed to the holes and a pressing belt on the external periphery of the mother base formed by upper and lower rows of a plurality of anti-skid pattern;

a son base which insert into the storage space and enable the user to choose to move in or out and fasten to a position; there are two elevated blocks which can move along the chute, and a plurality of horizontally adjustable slots disposed on the upper and lower elevated blocks corresponding to the openings with radial length not smaller than the diameter of the openings, two vertical adjustable slots formed adjacent to the lower position of the horizontal adjustable slot and the elevated block, and two tilting adjustable slots tilted and formed on the upper position of the vertical adjustable slot and the elevated block, and an upper/lower separated rows have a plurality of anti-skid pattern and formed a pressing belt on the outer periphery of the son base corresponding to the pressing belt of the mother base; and

a connection unit correspondingly connected to the son base which permits the user to adjust up/down or facing upward/downward and fastened to a position; the connection unit has two protective arms with upper and lower screw holes corresponding respectively to the tilted and vertical adjustable slots on the external lateral sides of the son base; two casings horizontally fastened to the head and tail of the protective arm, and two fastening elements disposed to the upper and lower screw holes; the front of the connection unit can be disassembled for fastening to the back of the display device or the back of the supporting object.

The added value of the present invention lies in permitting up/down and turning actions of the mother base on the fixed object and accommodates gliding and/or hub switch of the son base in the storage space, and carry out up/down and/or facing downward/upward actions through the connection unit with the son base as reference. Thus, it provides stable connection of different brands and different measurements of display devices to a fixed object (or its supporting rod) and for adjusting to the best viewing angle for the user.

### BRIEF DESCRIPTION OF THE DRAWINGS

FIG. 1 is a vertical exploded view of the first embodiment of the present invention.

FIG. 2 is a schematic diagram of FIG. 1 in a different angle.

FIG. 3 is a vertical exploded view of the second embodiment of the present invention.

FIG. 4 is a schematic diagram of the first embodiment of the present invention as an example for installing on the supporting rod of the fixed object.

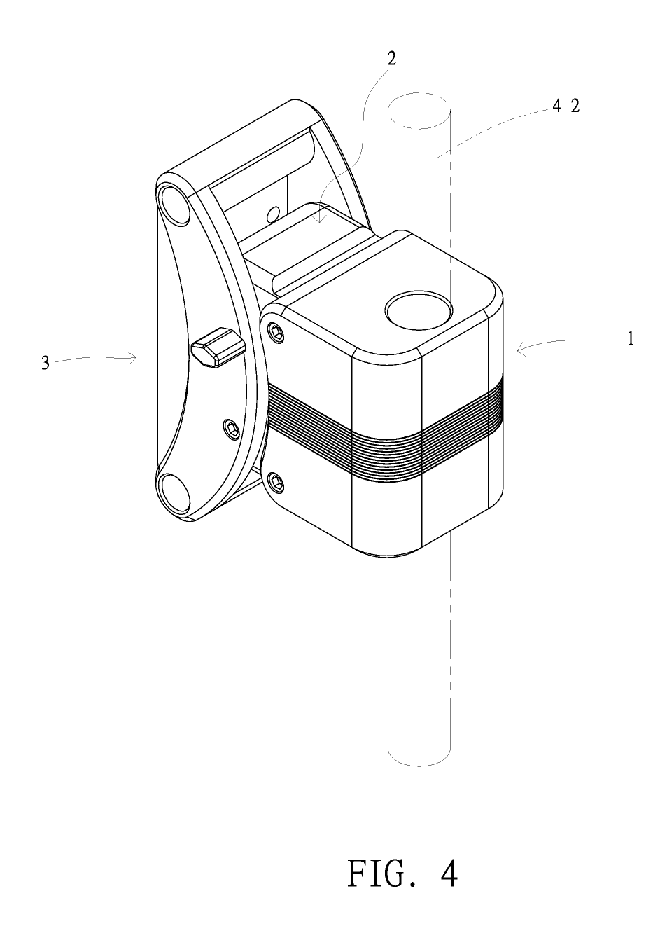

FIG. 5 is a schematic diagram of FIG. 4 in a different angle.

FIG. 6 is a schematic diagram of the first and second embodiments of the present invention showing assembly of the contact face of the connection unit with the plate member.

FIG. 7 is a schematic diagram of the first and second embodiments of the present invention showing fastening of the hanging rack vertically from the lateral sides of the rectangular frame body of the connection unit.

FIG. 8 is a schematic diagram of the first and second embodiments of the present invention showing fastening of the hanging rack vertically from the lateral sides of the rectangular frame body of the connection unit and then fastened to the display device.

FIG. 9 is a schematic diagram of the first and second embodiments of the present invention showing installation to the supporting rod of another fixed object.

FIG. 10 is a vertical exploded view of the third embodiment of the present invention.

FIG. 11 is a diagram showing completed assembly of FIG. 10.

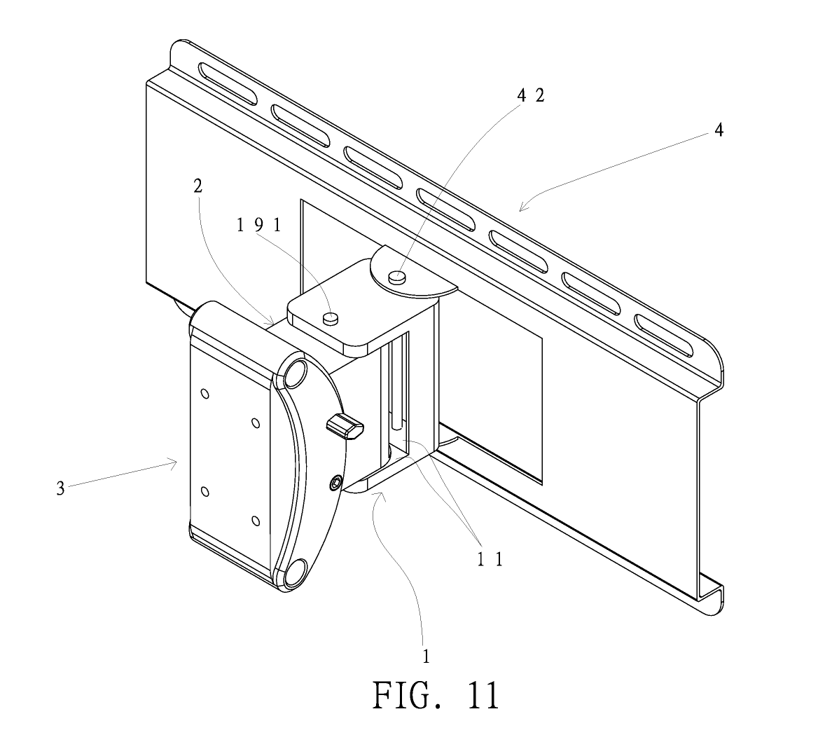

FIG. 12 is a schematic diagram of the third embodiment of the present invention showing permitted actions between the mother base, son base, the connection unit and the fixed object.

FIG. 13 is a vertical exploded view of the fourth embodiment of the present invention.

### DETAILED DESCRIPTION OF THE PREFERRED EMBODIMENTS

A specific embodiment is illustrated with drawings for detail description of the present invention where identical numerals are used for similar elements in the description.

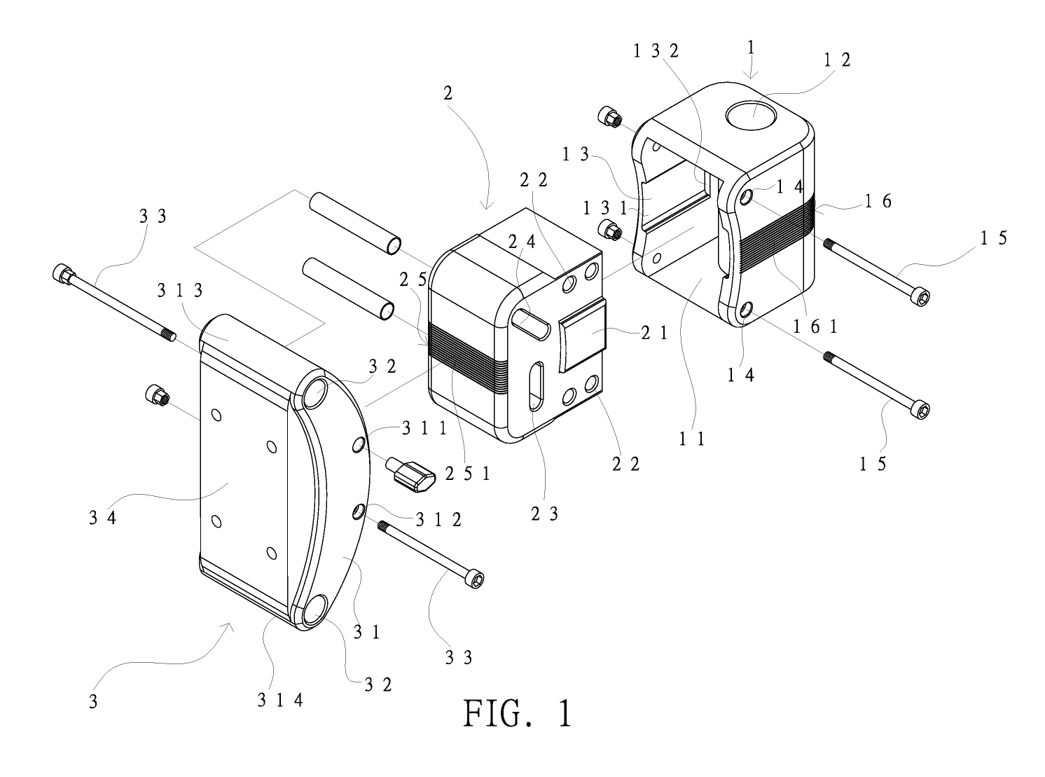

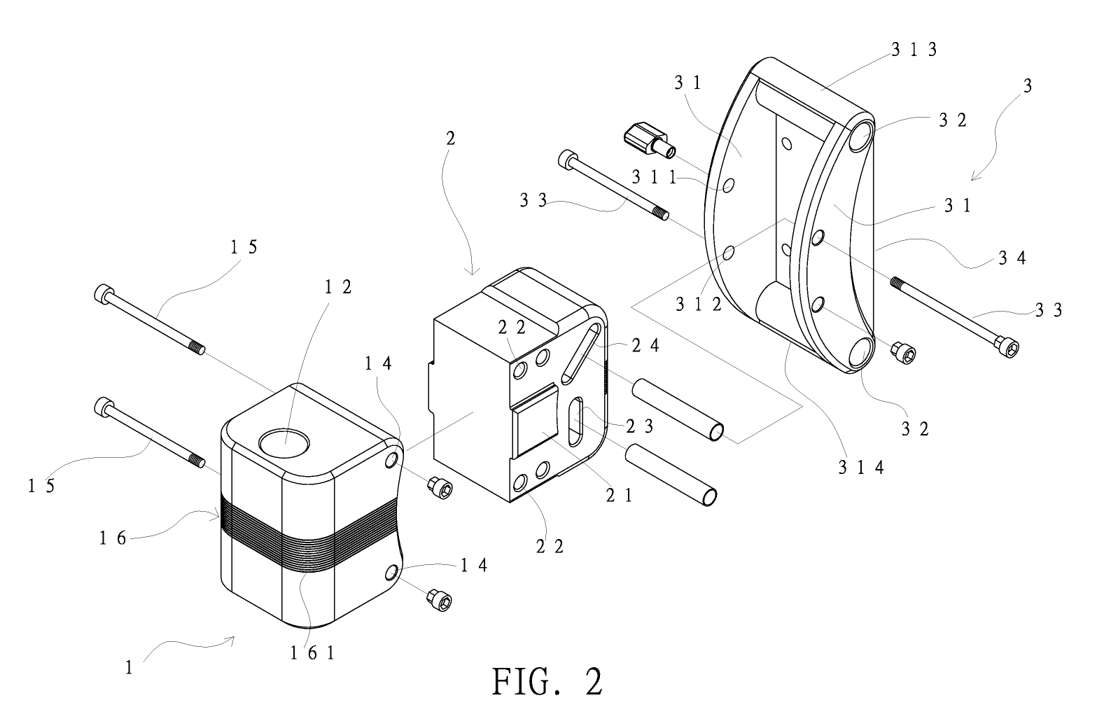

Refer to FIGS. 1, 2 and 8, the mounting kit of the first embodiment of the present invention comprises a mother base 1 and a son base 2 and a connection unit 3.

The mother base 1 is disposed on a fixed object 4 and it has a storage space 11 for the user to select and adjust the mother base up/down and left/right on the fixed object 4 and then fastened to a position. The mother base 1 has two openings 12 corresponding to the fixed object 4, and two respectively dented chutes 13 on the lateral sides inside the storage space 11 which is disposed with a starting end 131 for external connection with the mother base 2 and the starting end 131 successively correspond to the chute 13 of the end 132 inside the mother base 1; and two sets of openings 14 horizontally correspond to the upper and lower positions of the chute 13 and spatially adjacent to the starting end 131 of the chute 13, and two fastening elements 15 disposed to the openings 14, and a pressing belt 16 on the external periphery of the mother base 1 formed by a plurality of anti-skid patterns 161 in upper and lower separated rows.

The son base 2 is correspondingly connected to the storage space 11 and provides the user to choose to move inward or outward and then fastened to a position. There are two elevated blocks 21 which can move along the chute 13, and a plurality of horizontally adjustable slots disposed on the upper and lower elevated blocks 21 corresponding to the openings with radial length not smaller than the diameter of the openings 14, two vertical adjustable slots 23, 24 formed adjacent to the lower position of the horizontal adjustable slot 22 and the elevated block 21, and two tilted adjustable slots 24 tilted and formed on the upper position of the vertical adjustable slot 23 and the elevated block 21, and upper/lower separated rows with a plurality of anti-skid pattern 251 and formed a pressing belt 16 of the mother base 1 corresponding to the pressing belt 25 of the outer periphery of the son base 2.

The connection unit 3 is correspondingly connected to the son base 2 and provides the user to choose to adjust downward or upward and then fastened to a position. Its front can be disassembled for fastening to the back 52 of the display device 5 or the object 6 supporting the back 52.

The connection unit 3 has disposed the tilted and vertical adjustable slots 24, 23 on the external sides of the son base 2 which respectively correspond to the upper and lower screw holes 311, 312 of the protective arm 31 and two casings 32 which horizontally disposed to the head and tail 313, 314 of the protective arm 31, and two fastened elements 33 disposed to the upper and lower screw holes 311, 312. The connection unit 3 also has a contact face 34 between the casings 32 and the protective arms 31 of the son base 2.

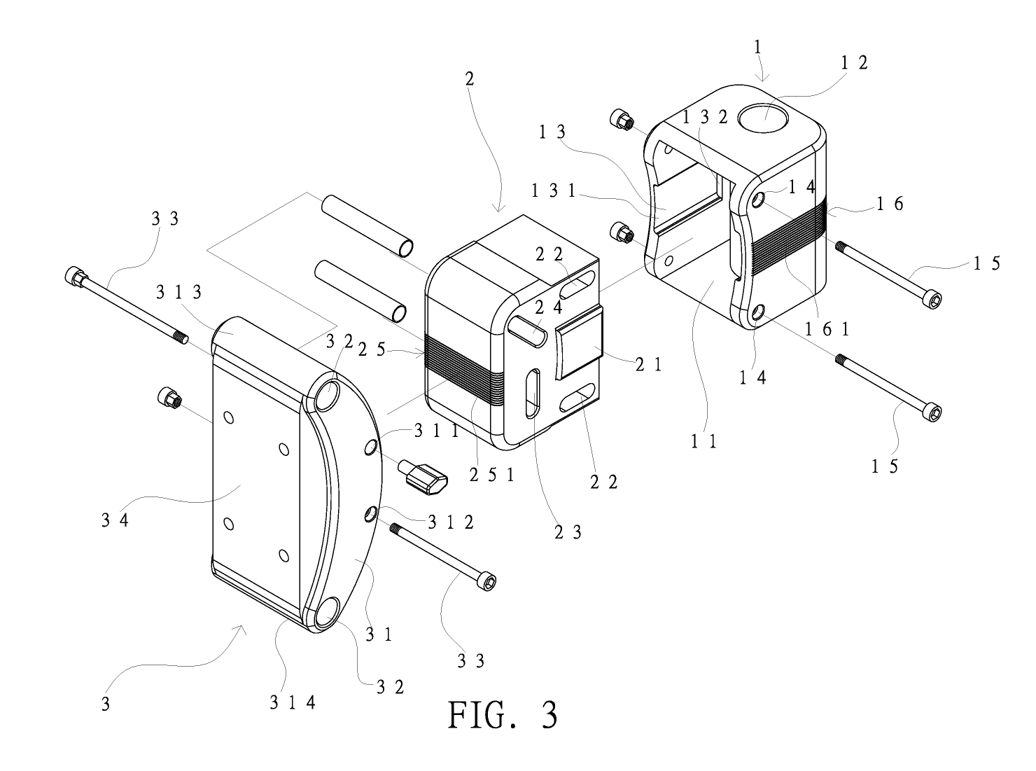

Referring to FIG. 3, the mounting kit of the second embodiment of the present invention differs from the first embodiment only in the design of the horizontal adjustable slots 22 of the son base 2; the horizontal adjustable slots 22 are respectively disposed to the upper and lower positions of the elevated block 21 and the radial length between the openings 14 is greater than the diameter of the opening 14 of the horizontal adjustable slot 22.

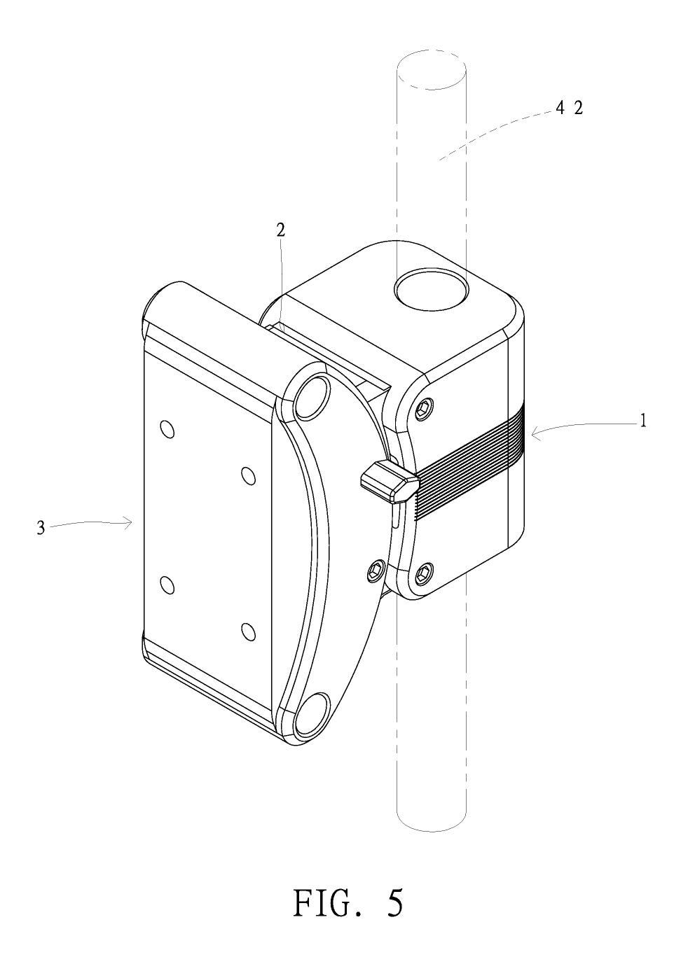

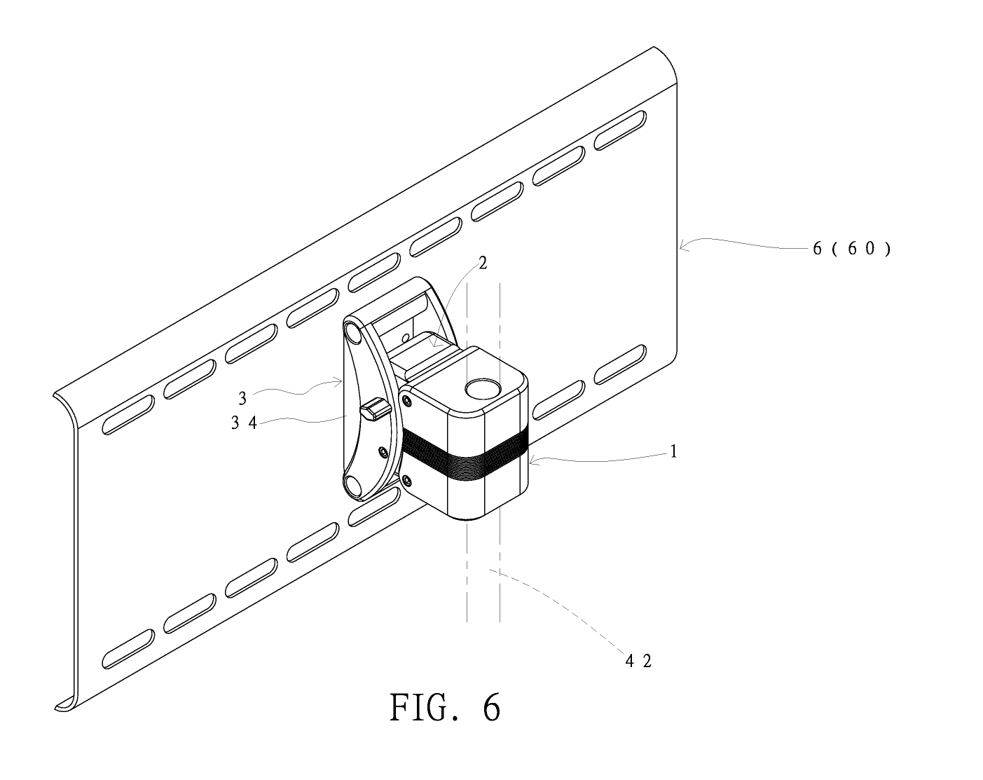

Through assembly of aforementioned elements, refer to FIGS. 1, 5 and 6 on usage of the first and second embodiments of the present invention. The user first disposed the opening 12 of the mother base 1 on the supporting rod 42 of a fixed object 4, and aligned the elevated block 21 of the son base 2 against the chute 13 of the storage space 11.

When the mother base 1 and the son base 2 come close together and allow the son base 2 in contact with the supporting rod 42, you can find out the corresponding openings 14 of the horizontal adjustable slot 22 and insert the fastening element 15 through the opening 14 and have it locked, thereby steadfastly disposed the mother base 1 and the son base 2 onto the supporting rod 42. After connecting the contact face 34 of the connection unit 3 apart from the elevated block 21 of the son base 2, the user has achieved an appropriate usage height through the fastening element 33 disposed to the screw hole 312 and the vertical adjustable slot 23 so the connection unit 3 can move up and down with reference to the son base 2. Use the fastening element 33 to insert and dispose to the screw hole 311 and the tilted adjustable slot 24 so that the connection unit 3 can get an appropriate usage angle facing downward or upward with reference to the son base 2. In the aforementioned embodiments, the object 6 is disposed to the plate member 60 of the contact face 34 and the front of the plate member 60 is for fastening to the back 52 of the display device 5. Therefore, the user only requires fastening the hack 52 of the display device 5 or the hack of the supporting object 6 against the contact face 34, thereby steadfastly connecting different brands and different measurements of display devices 5 onto the supporting rod 42, so that the user can achieve the purpose of adjusting an appropriate viewing angle.

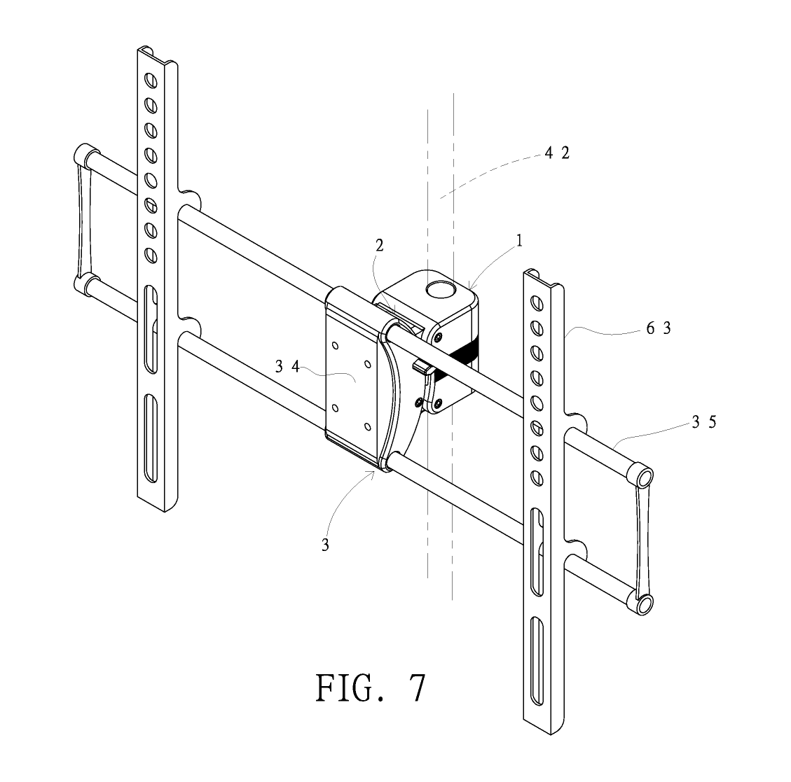

Refer to FIGS. 1, 3, 7 and 8, the connection unit 3 of embodiments 1 and 2 has disposed and fastened the casing 32 of the rectangular frame body 35, and vertically fasten a hanging rack 63 on both sides of the rectangular frame body 35, and the front of the hanging rack 63 is for fastening to the back 52 of the display device 5. Consequently, the user can achieve aforementioned purpose in the same manner.

Refer to FIGS. 1, 3 and 8, the contact face 34 of the connection unit 3 of embodiments 1 and 2 of the present invention is for assembling with the object 6 where the object 6 is a plate member 61, and the plate member 61 further vertically fastened to a hanging rack 62 from both sides, and the front of the hanging rack 62 is for fastening to the back 52 of the display device 5. The fixed object 4 has a base 40 for the vertical supporting rod 42. The base 40 has a plurality of partitions 402 for positioning of objects. The display device 5 could be LCD TV, LCD monitor, plasma TV and monitor or any one of these. Therefore, the user can achieve the aforementioned purpose in the same manner.

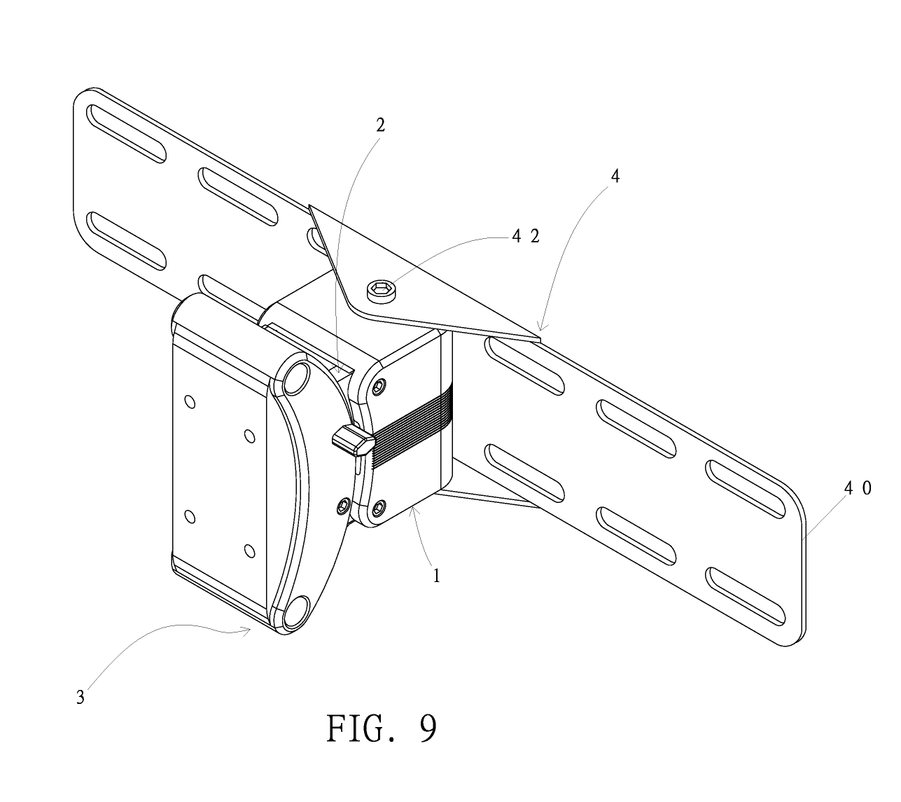

Referring to FIGS. 1, 3 and 9, in FIG. 9 the fixed object 4 is a base 40 with a vertical supporting rod 42. The fixed object 4 is suitable for disposing on the ceiling, wall and other surfaces. The supporting rod 42 disposes to the base 40 through the opening 12 of the mother base 1 and extend in the reverse direction of the wall to the baffle plate, thereby the user also can achieve aforementioned purpose.

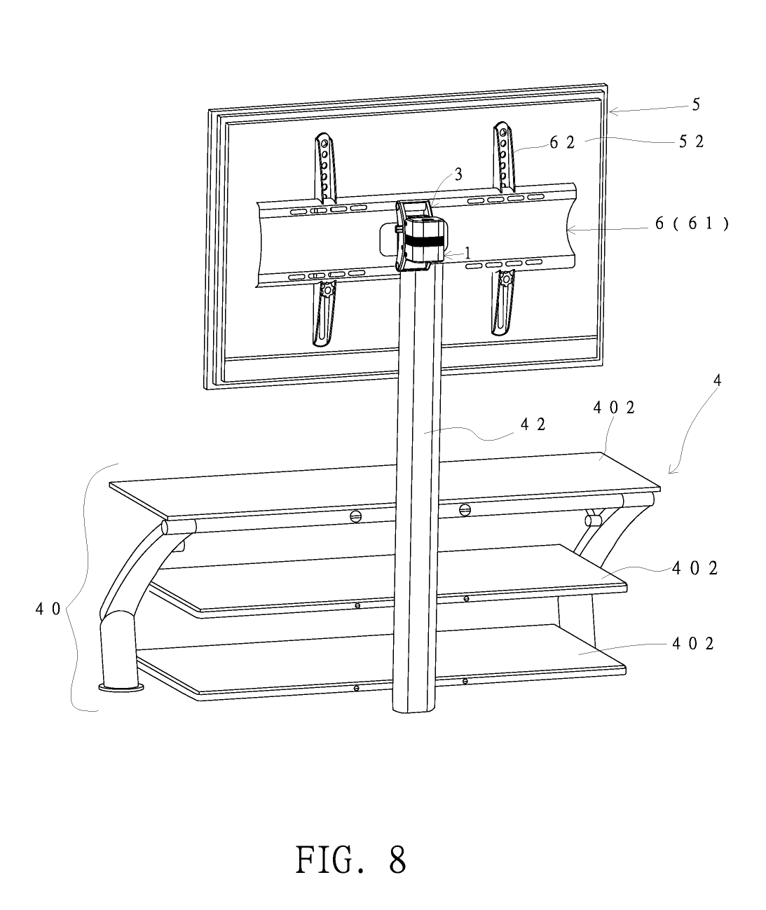

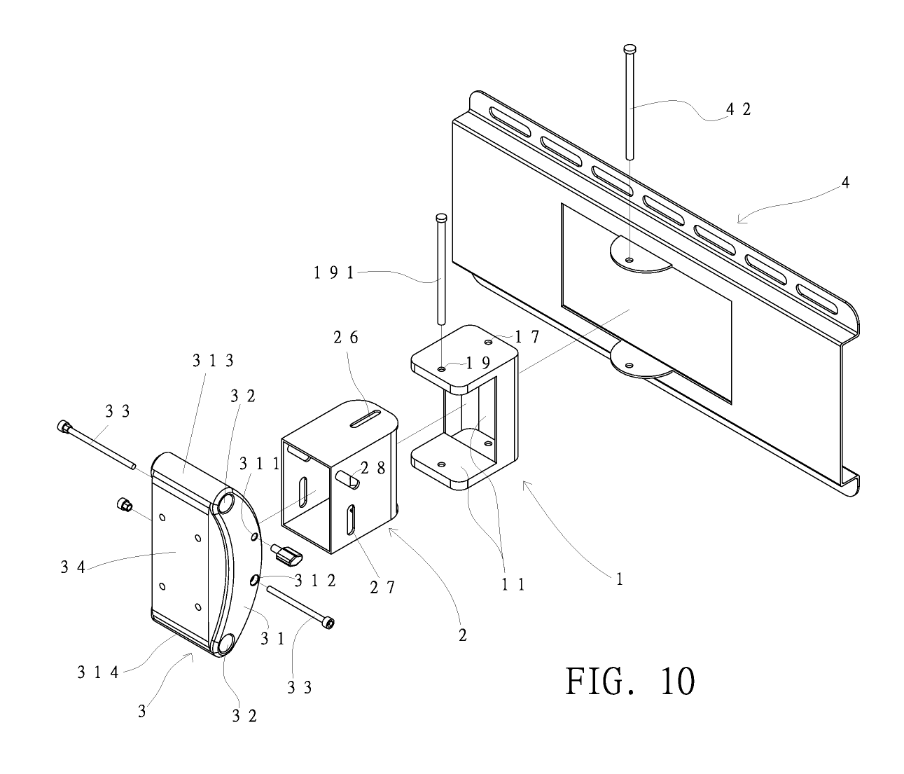

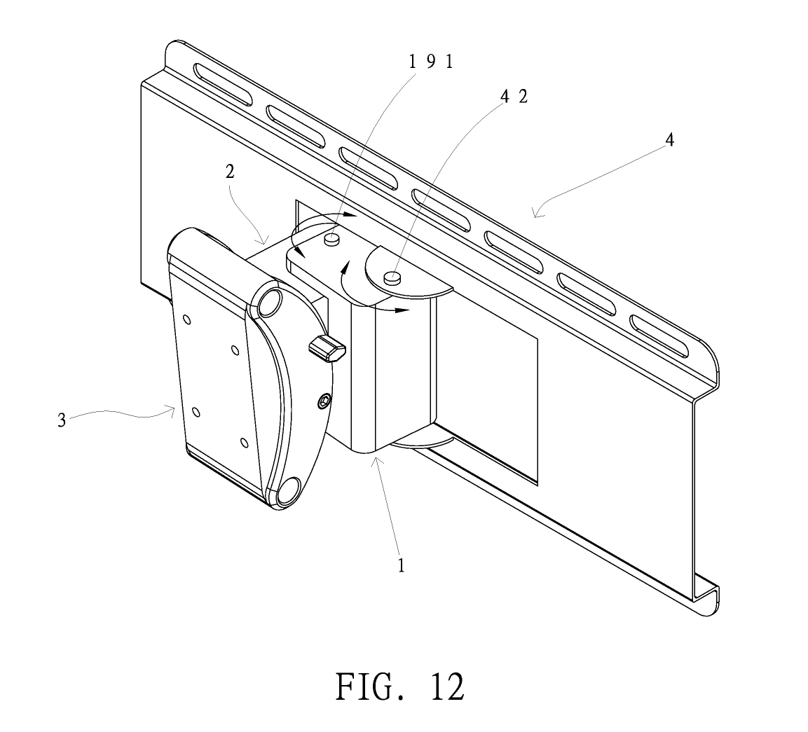

Referring to FIGS. 8, 10 and 12, and comparing with FIGS. 1 and 3, the mother base 1 of the third embodiment of the present invention has a storage space 11 which corresponds to the opening 17 of the supporting member 42 of the fixed object 4, and the opening 17 is spatially in the same axial direction for gliding by the son base 2 within the storage space 11/and a hub switch axial opening 19 and the first fastening element 191 disposed through the axial opening 17.

The son base 2 has two axial openings 19 which correspond to the first fixed element 191 of the horizontal adjustable slot 26, and the radial length of the horizontal adjustable slot 26 is greater than the diameter of the axial opening 19; and two vertical adjustable sluts 27 close to the lower lateral sides of the son base 2, and two tilted adjustable slots 28 located above the vertical adjustable slot 27 on the lateral sides of the son base 2.

The connection unit 3 has two protective arms 31 with upper and lower screw holes 311, 312 respectively corresponding to the tilted and vertical adjustable slots 24, 23 disposed on the external lateral sides of the son base 2, and the casings 32 horizontally fastened to the head and tail 313, 314 of the protective arm 31, and the fastening element 33 disposed to the upper and lower screw holes 311, 312. The connection unit 3 also has a contact face 34 which successively formed across the casings 32 in the direction away from the son base 2 and between the protective arms 31.

Through assembly of aforementioned elements, refer to FIGS. 8, 10 and 12, in using the third embodiment of the present invention you assemble the fixed object 4 on the surface of the wall, and through the mother base 1 turning inward or turning outward on fixed object 4, and coupled with the son base 2 having the mother base 1 as reference and glide and/or hub switch in the storage space 11, and carry out up/down or downward/upward actions through the connection unit 3 having the son base 2 as reference to steadfastly fasten different brands and different measurements of display devices 5 to the supporting rod 42 and achieve the purpose of adjusting the best viewing angle for the user.

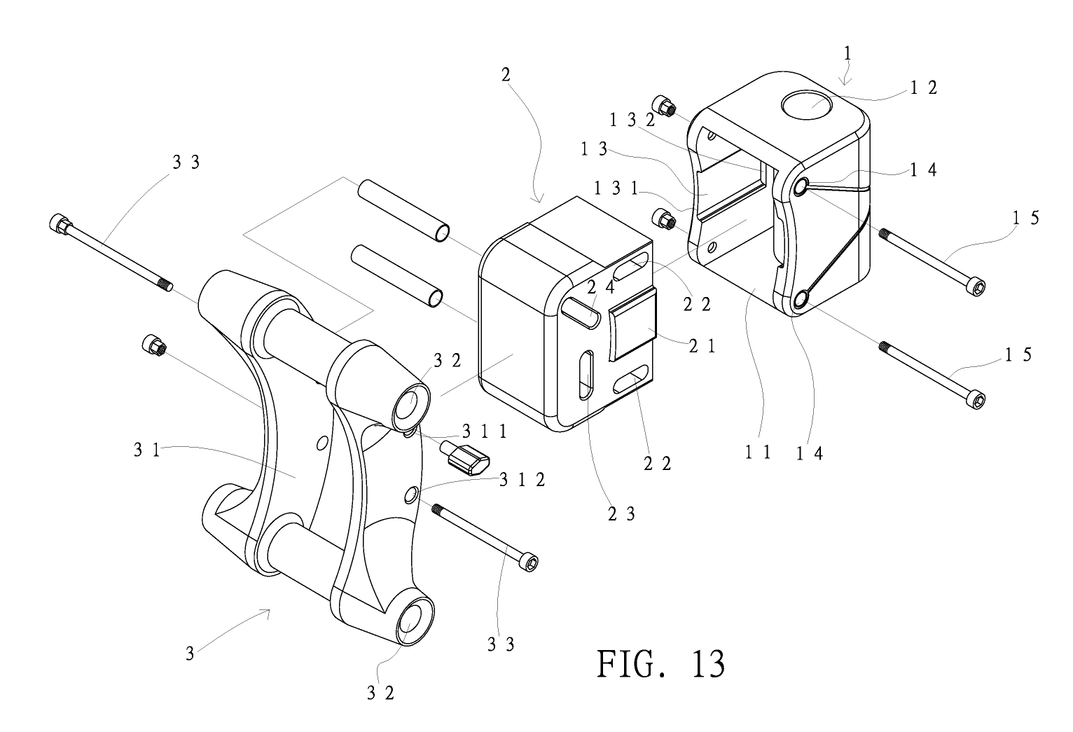

As shown in FIG. 13, you may compare the elements with FIG. 1. The contact face 34 of the connection unit 3 in FIGS. 1˜12 may be omitted or added according to practical requirements and is not limited thereof.

Although the present invention has been described in detail by aforementioned embodiments, they are for easy understanding of the present invention by those who are skilled in the art and not to limit the scope of embodiments of the present invention; therefore, all changes and modifications to the feature and guideline of the appearance and structure of the present invention belong to the scope of claims of the patent for the present invention.

What is claimed is:

1. A mounting kit comprising:
a mother base disposed to a fixed object which permits the user to choose to move up/down and/or turning and make adjustment and fasten to a position; the mother base has a storage space, and two openings corresponding to the fixed object, two chutes respectively dented and formed on the internal lateral surfaces of the storage space and disposed with a starting end externally connected to the mother base and successively and correspondingly connected to the internal end of the mother base, two sets of openings horizontally correspond to the upper and lower positions of the chute and spatially adjacent to the starting end of the chute; two fastening elements disposed to the openings, and a pressing belt with upper and lower rows of a plurality of anti-skid patterns formed on the outer periphery of the mother base;
a son base correspondingly connected to the storage space which permits the user to choose to move inward or outward and fasten to a position; the son base has two elevated blocks permitting movement of the chute, and a plurality of horizontal adjustable slots respectively disposed to the upper and lower positions of the elevated blocks and openings with radial length not less than the diameter of the openings, two vertical adjustable slots formed to the lower position of the horizontal adjustable slots and adjacent to the elevated blocks; two tilted adjustable slots formed above the vertical adjustable slot and adjacent to the elevated block, and a pressing belt on the external periphery of the son base which correspond to the pressing belt of the mother base formed by upper and lower rows of a plurality of anti-skid pattern; and
a connection unit correspondingly connected to the son base which allows the user to choose to adjust up/down or facing downward/upward and fastened to a position; the connection unit has two protective arms disposed to the two external lateral sides of the son base with tilted and vertical adjustable slots respectively corresponding to the upper and lower screw holes, two casings horizontally fastened to the head and tail of the protective arm, and two fastening elements disposed to the upper and lower screw holes; the front of the connection unit can be disassembled for fastening to the back of the display device or the back of the supporting rod.

2. A mounting kit according to claim 1, wherein the connection unit has a contact face in the direction away from the son base and is successively formed across the casings and between the protective arms.

3. A mounting kit according to claim 2, wherein the object is a plate member disposed to the contact face and the front of the plate member is for fastening to the back of the display device.

4. A mounting kit according to claim 2, wherein the object is a plate member disposed to the contact face and the plate member further vertically fastens to a hanging rack from both lateral sides while the front of the hanging rack is for fastening to the back of the display device.

5. A mounting kit according to claim 2, wherein the connection unit has a rectangular frame body disposed and fastened to the casing, and the rectangular frame body vertically fastened to a hanging rack from both lateral sides and the front of the hanging rack is for fastening to the back of the display device.

6. A mounting kit comprising:
a mother base disposed to a fixed object which permits the user to choose to make up/down and/or left/right turning adjustment and then fastened to a position; the mother base has a storage space and two openings corresponding to the supporting member of the fixed object, two axial holes spatially on the same axial direction with the openings and allow the son base to glide/and hub switch in the storage space, and the first fastening element disposed to the axial hole;
a son base correspondingly connected to the storage space and permits the user to choose to move inward or outward and then fastened to a position, the son base has two horizontal adjustable slots corresponding to the axial holes and the first fastening element where the horizontal adjustable slots with radial length greater than the diameter of the axial hole, and two vertical adjustable slots formed underneath the lateral sides of the son base, and two tilted adjustable slots formed above the vertical adjustable slot on the lateral sides of the son base; and
a son base correspondingly connected to the storage space which permits the user to choose to move inward or outward and then fastened to a position; the son base has disposed titled and vertical adjustable slots above the external lateral sides of the son base which respectively correspond to the protective arms with upper and lower screw holes, two casings horizontally fastened to the head and tail of the protective arms, and fastening elements disposed to the upper and lower screw holes, and the front of the connection unit can be disassembled for fastening to the back of the display device or the back of the supporting object.

7. A mounting kit according to claim 6, wherein the connection unit also has a contact face in the direction away from the son base which is formed across the casings and between the protective arms.

8. A mounting kit according to claim 7, wherein the object is the plate member disposed to the contact face and the front of the contact face is for fastening to the hack of the display device.

9. A mounting kit according to claim 7, wherein the object is the plate member disposed to the contact face, and the plate member further vertically fastened to the hanging rack from the lateral sides and the front of the hanging rack is for fastening to the back of the display device.

10. A mounting kit according to claim 7, wherein the connection unit has a rectangular frame body respectively disposed to the casings, and vertically fastened to a hanging rack from the lateral sides of the rectangular frame body, and the front of the hanging rack is for fastening to the back of the display device.
